(19) United States
(12) Patent Application Publication
(10) Pub. No.: US 2012/0141304 A1
(43) Pub. Date: Jun. 7, 2012

(54) Pump Housing for a Hydraulic Unit in a Motor Vehicle

(76) Inventors: Matthias Mayr, Rettenberg (DE); Marc Micke, Boennigheim (DE); Reiner Fellmeth, Besigheim (DE); Alexander Bareiss, Immenstadt (DE); Andreas Weh, Sulzberg (DE)

(21) Appl. No.: 13/321,797

(22) PCT Filed: Mar. 23, 2010
(86) PCT No.: PCT/EP10/53739

§ 371 Date: Feb. 11, 2012

(30) Foreign Application Priority Data
May 22, 2009 (DE) 10 2009 026 417.5

(51) Int. Cl. F04B 53/16; B23P 15/00; B23Q 3/06; B23P 13/00

(52) U.S. Cl. 417/321; 269/329; 29/888.02

(57) ABSTRACT

A pump housing for a hydraulic unit in a motor vehicle, includes a body that is provided with openings for accommodating components of an associated pump. One of the external surfaces of the body is designed such that a motor can be mounted thereon. A cutting process is not used to machine the external surface for mounting the motor.

The invention relates to a pump housing for a hydraulic unit in a motor vehicle, which is configured with a body in which orifices for the reception of components of an associated pump are located and which is adapted on one of its outer faces for mounting a motor. The invention relates, furthermore, to a device for holding a pump housing for a hydraulic unit in a motor vehicle during the cutting machining of said pump housing for the formation of orifices for the reception of components of the associated pump. Finally, the invention also relates to a method for producing a pump housing for a hydraulic unit in a motor vehicle.

### PRIOR ART

Hydraulic units are used in motor vehicles such as, for example, passenger cars or motor trucks, in order to provide regulated brake pressures in their brake system. In particular, functions of an antilock system (ABS), traction control (ASR) and/or an electronic stability program (ESP) are implemented by means of hydraulic units of this type. For metering the brake pressures, the hydraulic units have, as a rule, a pump with a plurality of pump pistons and with an associated motor and also a multiplicity of valves. The valves are usually controlled electromagnetically and thus make it possible to provide different brake pressures on individual brakes or brake circuits.

An object of the invention is to provide a pump housing for a hydraulic unit in a motor vehicle, which pump housing can be produced more cost-effectively than known pump housings.

### DISCLOSURE OF THE INVENTION

The object is achieved by means of a pump housing according to claim 1, a device according to claim 3 and a method for producing a pump housing according to claim 4. Advantageous developments are described in the dependent claims.

According to the invention, a pump housing for a hydraulic unit in a motor vehicle is provided, which is configured with an especially solid body in which orifices for the reception of components of an associated pump are located and which is adapted in one of its outer faces for mounting a motor of the associated pump, the pump housing being characterized in that the outer face for mounting the motor has not been machined by means of a cutting method.

In known pump housings for hydraulic units in motor vehicles, the outer face provided for mounting the associated motor is always machined by means of a cutting manufacturing method. In known pump housings, a reference face is thus formed, on which the motor is mounted, but which is also at the same time a reference face for machining the orifices in the pump housing. Hydraulic components of the associated pump are subsequently arranged in these orifices. Such components are at least two pump pistons which are mounted displaceably in the pump housing and serve for pumping the associated hydraulic fluid in the pump housing. The pump pistons are in this case driven by an eccentric which is located on the drive shaft of the associated motor. Owing to said reference face which, as explained above, in known pump housings is formed especially as a result of a cutting manufacturing method such as for example, milling, it becomes possible to provide a defined or exact spatial assignment between these pump pistons and the eccentric. Only thereby is the proper functioning of the pump of known hydraulic units ensured.

In the solution according to the invention, such a reference face produced by cutting machining has deliberately been dispensed with. According to the invention, a blank of a pump housing is clamped in an associated device in such a way that the outer face of the blank is pressed against a stop and is held fixedly there during the machining and, in particular, the shaping of the orifices for the reception of components of the associated pump. The pump housing can consequently be smaller and lighter as a blank and can therefore also be produced more cost-effectively. Furthermore, a machining operation, in particular a milling operation, on an outer face of the blank is dispensed with, with the result that the outlay in production terms is reduced, the associated costs fall and the net product can be increased. Furthermore, secondary measures such as, for example, deburring of an outer face, are also avoided.

An interface for the motor can thus be formed, without cutting machining, on that outer face of the pump housing which is assigned to the motor. This interface overlaps between the cut region and the unmachined region on the outer face (stop for a flange of the motor). According to the invention, the prestressing force tolerance of the motor, which is influenced by the path tolerance during the machining of the pump housing on the device, can in this case be restricted to a required value or acceptable range.

The axial tolerance between the cut contour or cut region within the blank and the blank surface is reduced, according to the invention, to the tolerance of the displacement travel of the associated cutting manufacturing plant (as a rule, an NC axis of a milling machine).

In an advantageous development of the pump housing according to the invention, the latter has been pressed against a stop of a device holding the pump housing during the formation of the orifices for the reception of hydraulic components of the associated pump on the outer face for mounting the motor. What is achieved by pressing in this way is a fixed positioning of the pump housing during cutting manufacture, thus allowing dimensionally accurate cutting, while at the same time adhering to the required tolerances between the inside of the pump housing and the outer face for mounting the motor or between the cut (machined) and uncut region.

In the solution according to the invention, furthermore, a device is provided for holding a pump housing for a hydraulic unit in a motor vehicle during the cutting machining of said pump housing for the formation of orifices for the reception of components of the associated pump, in which device is provided a stop for laying the untreated pump housing in place by means of that of its outer faces which is subsequently the outer face for mounting a motor of the associated pump on the pump housing. Thus, as already explained above, the device makes it possible to utilize the unmachined outer face for mounting the motor as a reference face even during cutting manufacture. For this purpose, the device is preferably provided with a plurality of relatively small, spatially limited stop faces which, in particular, come to bear against or in the vicinity of the corners of said outer face.

In the solution according to the invention, finally, a method is also provided for producing a pump housing for a hydraulic unit in a motor vehicle, having the following steps: firstly, laying in place the untreated pump housing, not machined by cutting, with one of its outer faces against a stop, and secondly formation, by cutting machining, of orifices for the reception of components of an associated pump on said outer face and on further outer faces of the pump housing, inter alia an orifice for the reception of part of a motor of the associated pump being formed on said outer face.

Said method according to the invention is advantageously developed, furthermore, by virtue of the following step: tensioning of the pump housing against said outer face with a force that is greater than the forces acting on the pump housing during cutting machining. Such a tensioning force ensures that the pump housing is always held fixedly on the associated device during machining. Alternatively, it is also possible to lock the pump housing in the device in a positive-locking manner.

### BRIEF DESCRIPTION OF THE DRAWINGS

Exemplary embodiments of the solution according to the invention are explained in more detail below with reference to the accompanying drawings in which:

FIG. 1 shows a perspective view of a device for holding a pump housing for a hydraulic unit in a motor vehicle according to the invention,

FIG. 2 shows a side view of the device according to FIG. 1,

FIG. 3 shows a top view of the device according to FIG. 1 and

FIG. 4 shows a perspective view of a glass model of an

ABS pump housing according to the prior art and according to the invention.

### EMBODIMENTS OF THE INVENTION

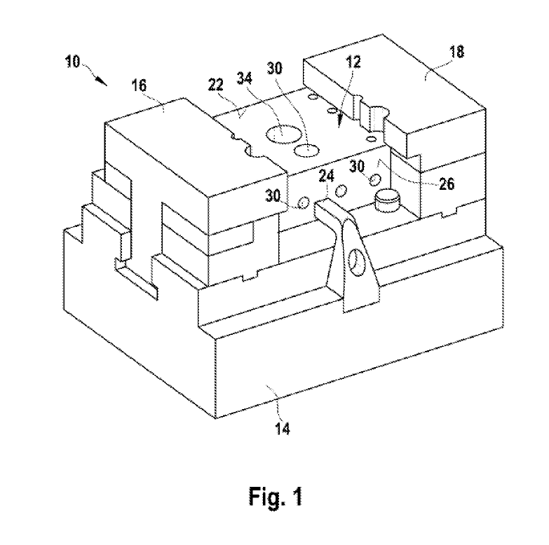

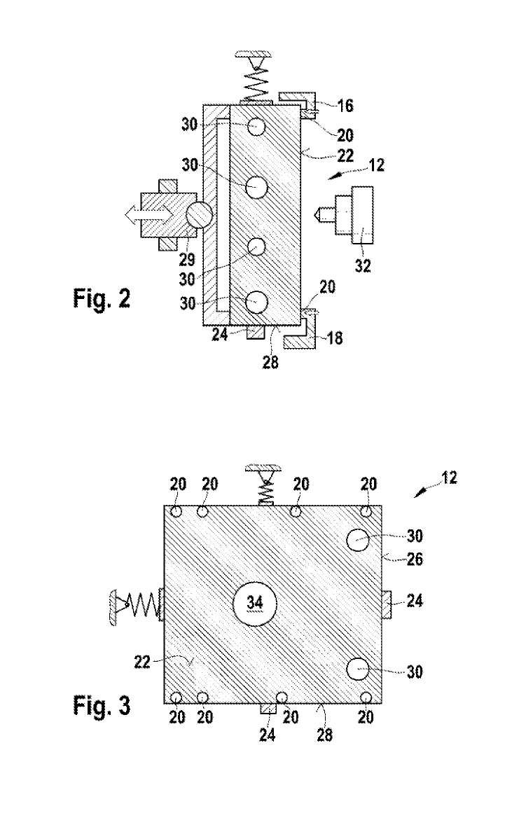

FIG. 1 illustrates a device 10 for holding a parallelepipedal pump housing 12, formed from an aluminum block, of a motor vehicle hydraulic unit, not illustrated in any more detail. The device 10 is configured with a baseplate 14 from which two clamping jaws 16 and 18 project upward in relation to the figure. The clamping jaws 16 and 18 are attached fixedly to the baseplate 14. The clamping jaws 16 and 18 have in each case, for this purpose, two stops or stop faces 20 at which the pump housing 12 bears from below against the respective clamping jaw 16 and 18. In this case, the inner four stop faces 20 illustrated in FIG. 3 are intended for an ABS pump housing (see also FIG. 5), while the outer four stop faces 20 illustrated in FIG. 3 are intended for an ESP pump housing (see also FIG. 7). In the present case, the stop faces 20 are configured as circular faces (see FIG. 3), but in other embodiments may also assume other geometric basic forms and other numbers.

The pump housing 12 bears against the stop faces 20 with an essentially planar, untreated outer face 22 which subsequently serves for mounting a motor (not illustrated) of the motor vehicle hydraulic unit.

Furthermore, on the baseplate 14, two stops 24 are provided, against which the parallelepipedal pump housing 12 bears with a side face 26 and a side face 28. The pump housing 12 is in this case forced from below by means of a hydraulic or pneumatic ram 29 and from the side against the respective stops or stop faces.

Various orifices 30 for the reception of components of an associated pump are shaped in a cutting manufacturing method on the pump housing 12 held in this way. Subsequently, for example pump pistons (not illustrated) and, if appropriate, valves (not illustrated) are inserted as components into the orifices 30. In this case, an orifice 34 is drilled into the outer face 22, in particular by means of a tool 32, and subsequently serves for receiving a bearing (not illustrated) and an eccentric (not illustrated) of the motor. The outer face 22 itself, by contrast, remains untreated and is not milled over.

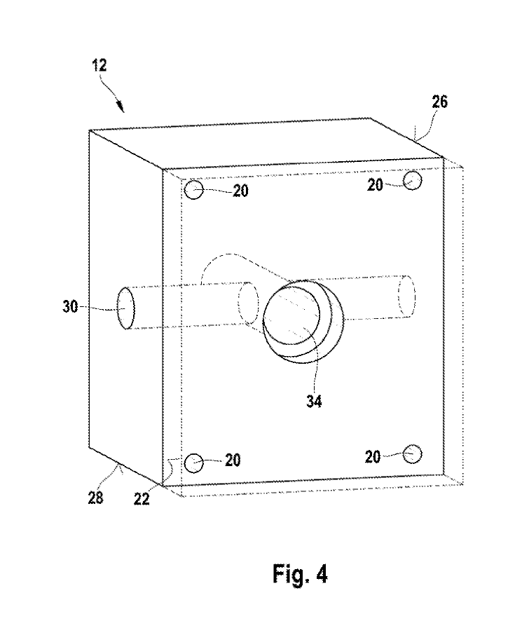

FIG. 4 shows that a small blank can be used, in comparison with known procedures, for the pump housing 12 by means of the device 10 and the associated cutting manufacturing method for the orifices 30.

1. A pump housing for a hydraulic unit in a motor vehicle, comprising:
a body in which orifices for the reception of components of an associated pump are located and which is adapted on one of its outer faces for mounting a motor,
wherein the outer face for mounting the motor has not been machined by means of a cutting method.

2. The pump housing as claimed in claim 1, wherein the pump housing has been pressed against a stop of a device holding the pump housing during the formation of the orifices for the reception of components of the associated pump on the outer face for mounting the motor.

3. A device for holding a pump housing for a hydraulic unit in a motor vehicle during the cutting machining of said pump housing for the formation of orifices for the reception of components of the associated pump, comprising:
a stop for laying the untreated pump housing in place by means of that of its outer faces which is subsequently the outer face for mounting a motor on the pump housing.

4. A method for producing a pump housing for a hydraulic unit in a motor vehicle, comprising:
laying in place an untreated pump housing, not machined by cutting, with one of its outer faces, against a stop; and
forming, by cutting machining, of orifices for the reception of components of an associated pump on said outer face and on further outer faces of the pump housing, an orifice for the reception of part of a motor being formed on said outer face.

5. The method as claimed in claim 4, further comprising:
tensioning the pump housing against said outer face with a force that is greater than the forces acting on the pump housing during cutting machining.
